(19) United States
(12) Patent Application Publication
(10) Pub. No.: US 2012/0227294 A1
(43) Pub. Date: Sep. 13, 2012

(54) Automobile Protection Device

(76) Inventor: Thomas Weber, Bronx, NY (US)

(21) Appl. No.: 13/418,002

(22) Filed: Mar. 12, 2012

Related U.S. Application Data
(60) Provisional application No. 61/451,662, filed on Mar. 11, 2011.

(51) Int. Cl. B60R 11/00

(52) U.S. Cl. 40/209

(57) ABSTRACT

An automobile protection device having a first frame and a second frame. The first frame has an inner edge and an outer edge. A plurality of semi-circular tabs extend from the inner edge having circular holes. The outer edge of the first frame integrally couples the first frame with the second frame such that the first frame extends outwardly from the second frame. The inner edge of the first frame secures the license plate to the fender by aligning the circular holes of the first frame with the existing holes in a standard license plate and fender of an automobile and securing the device using screws. When in position, the device extends perpendicularly outwardly from the fender to prevent damage to the license plate and fender of an automobile.

### CROSS-REFERENCE TO RELATED APPLICATION

This application claims the benefit of and takes priority from U.S. App. No. 61/451,662 filed on Mar. 11, 2011, the contents of which are hereby incorporated by reference.

### BACKGROUND OF THE INVENTION

1. Field of the Invention

This invention relates generally to automobiles and more particularly, to a specially designed automobile protection device for securing and protecting a license plate while preventing damage to the fender of an automobile. Specifically, the automobile protection device has a first frame surround by a second frame and provides an easy to use and aesthetically pleasing device with unparalleled protection attributes.

License plates on automobiles, trucks or motorcycles are often bent and damaged by debris, road obstacles, car washes, and collisions with other cars. In addition, the front and back fenders of an automobile are often damaged by day to day driving, especially parallel parking in urban cities. An automobile protection device is essential to help protect a license plate and prevent damage to the plate and fender. The specific design, the material and size are important considerations when designing a suitable automobile protection device. Other factors must also be simultaneously considered including ease of attachment to the automobile, aesthetics, and weight.

The most widely used devices for providing protection to an automobile are typically made out of metal or hard plastic. Most of these devices only protect the edges of a license plate. A few designs also protect the face of a license plate with a transparent shield. These devices have several limitations as they do not protect the front or back fender of an automobile and do not adequately surround the license plate to provide the needed protection.

Until now, all known protection devices crack, chip, or break. Furthermore, current devices do not prevent rust on a license plate. Damage to the front or back fender and rust on a license plate diminishes the aesthetic value of the automobile.

Current designs of protection devices also do not fully protect the fenders of automobile from scratches, dents, and rust. This lack of protection is one reason for high automobile insurance in the United States. On average automobile owners pay $1,000.00-$3,000.00 per year on car insurance. Without proper protection for license plates and fenders, these insurance premiums will continue to rise.

The present invention seeks to improve the automobile industry by providing an automobile protection device like no other. This automobile protection device secures a license plate, to the fender, while at the same time protecting the license plate and the fender from damage.

2. Description of the Related Art

U.S. Pat. No. 5,819,449 to Molson discloses a protective nonstick cover for a standard automobile license plate having a nonstick surface which is easy to clean, protects the license plate, and enhances and/or improves the appearance of the license plate. The standard license plate is generally rectangularly-shaped and has a front surface with identification characters embossed therein. The protective nonstick cover includes a generally rectangularly-shaped and generally flexible plastic film sized to closely match the front surface of the license plate and a pressure-sensitive adhesive layer applied directly to a rear surface of the plastic film. The adhesive layer secures the plastic film to the entire front surface of the license plate to form a laminate. The plastic film and the adhesive layer are transparent when attached to the license plate so that the identification characters of the license plate are visible therethrough. Preferably, the plastic film is an ethylene based on unplasticized ionomer film.

U.S. Pat. No. 5,950,339 to Lucier discloses an improved license plate protector comprising a one piece flexible cover made of relatively high impact strength poly-carbonate resin, which remains substantially transparent damage resistant even upon marring, scratching and weathering of the cover during use. The plate protector further comprises an improved structural technique for position and securing a one piece, light weight plate protector to a license plate and motor vehicle, and protecting the license plate, through the combined use of a perimeter rib, retaining tabs, a plurality of positioning tabs, corresponding attachment locations and a plurality of attachment holes. A method of making a license plate protector as describe comprises the steps of drying polycarbonate resin with a heater, a forming a license plate protector by application of heat and pressure to such resin in a molding device having mold surfaces comprising material selected from the group consisting of stainless steel and chrome plating.

U.S. Pat. No. 6,760,986 to MacNeil discloses a license plate cover with a transparent plastic frame and an elastomeric gasket. The frame includes a periphery and an inner side for disposal adjacent to a license plate. The elastomeric gasket is disposed on the inner side near the periphery of the frame. The gasket includes first and second elongate compression ribs which protrude inwardly from the inner side of the frame to different degrees thereby forming a surface that receives a beveled license plate. The elastomer making up the gasket may be furnished with a colorant such that a colored peripheral band is visible through the frame from the front.

While these units may be suitable for the particular purpose employed, or for general use, they would not be as suitable for the purposes of the present invention as disclosed hereafter.

### SUMMARY OF THE INVENTION

It is an object of the invention to provide a protection device for an automobile which prevents damage to the license plates and the front and back fenders. Accordingly, the present invention is an automobile protection device having two substantially rectangular frames, a first frame secures a license plate to the fender of an automobile while a second frame surrounds the first frame and protects the fender from damage.

It is an object of the invention to provide an automobile protection device which can absorb the impact of a minor collision thereby protecting the license plate and fender of an automobile. Accordingly, the first and second frames of the present device are preferably made from rubber to deflect and prevent damage to the license plate and fender from a minor collision.

It is an object of the invention to provide an automobile protection device capable of preventing minor bumps and dents in the front and back fenders of an automobile. Accordingly, the first and second frames of the present device extend outward perpendicularly from the fender of the automobile providing a wide barrier of protection around the license plate and along the fender to prevent damage.

It is an object of the invention to provide an automobile protection device which protects edges of a license plate from bending. Accordingly, the first frame of the present device covers the perimeter of a standard license plate and prevents the license plate from bending and damage caused by day to day driving.

It is another object of the invention to provide an automobile protection device which easily mounts to all automobiles. Accordingly, the first frame of the present invention utilizes the existing holes in a standard license plate and fender to couple the device to an automobile.

It is another object of the invention to provide an automobile protection device which is capable of reducing automobile insurance premiums. Accordingly, the first and second frames of the present device provide increased protection to the licenses plates and front and back fenders of an automobile therefore reducing damage to the automobile.

It is another object of the invention to provide an aesthetically pleasing device. Accordingly, the automobile protection device of the present invention includes a plurality of colors, designs and slogans to suit an automobile owner's preference.

It is another object of the invention to provide an automobile protection device which is customizable. Accordingly, the first and second frames of the present device are customizable according to the automobile owner's preference via an online website whereby colors, logos, and slogans are interchangeable.

This invention is an automobile protection device having a first frame and a second frame. The first frame has an inner edge and an outer edge. A plurality of semi-circular tabs extend from the inner edge having circular holes. The outer edge of the first frame integrally couples the first frame with the second frame such that the first frame extends outwardly from the second frame. The inner edge of the first frame secures the license plate to the fender by aligning the circular holes of the first frame with the existing holes in a standard license plate and fender of an automobile and securing the device using screws. When in position, the device extends perpendicularly outwardly from the fender to prevent damage to the license plate and fender of an automobile.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reference numerals. The drawings are briefly described as follows.

FIG. 1 is a front plan view of the automobile protection device of the present invention having a first and second frame.

FIG. 2 is an exploded cross-sectional view of the automobile protection device of the present invention taken generally on line 2-2 of FIG. 1, wherein the first frame secures a license plate and couples with the front fender of an automobile.

FIG. 3 is an exploded cross-sectional view of an alternate embodiment of the automobile protection device of the present invention illustrating an alternative method of securing a license plate within the first frame.

FIG. 4 is a front-side perspective view of an alternative embodiment of the automobile protection device of the present invention illustrating a recessed back surface extending inwardly from the first frame.

FIG. 5 is a cross-sectional view of an alternate embodiment of the automobile protection device along line 4-4 of FIG. 4, wherein a license plate is secured against the recessed back surface of the present invention.

### DETAILED DESCRIPTION OF THE PREFERRED EMBODIMENTS

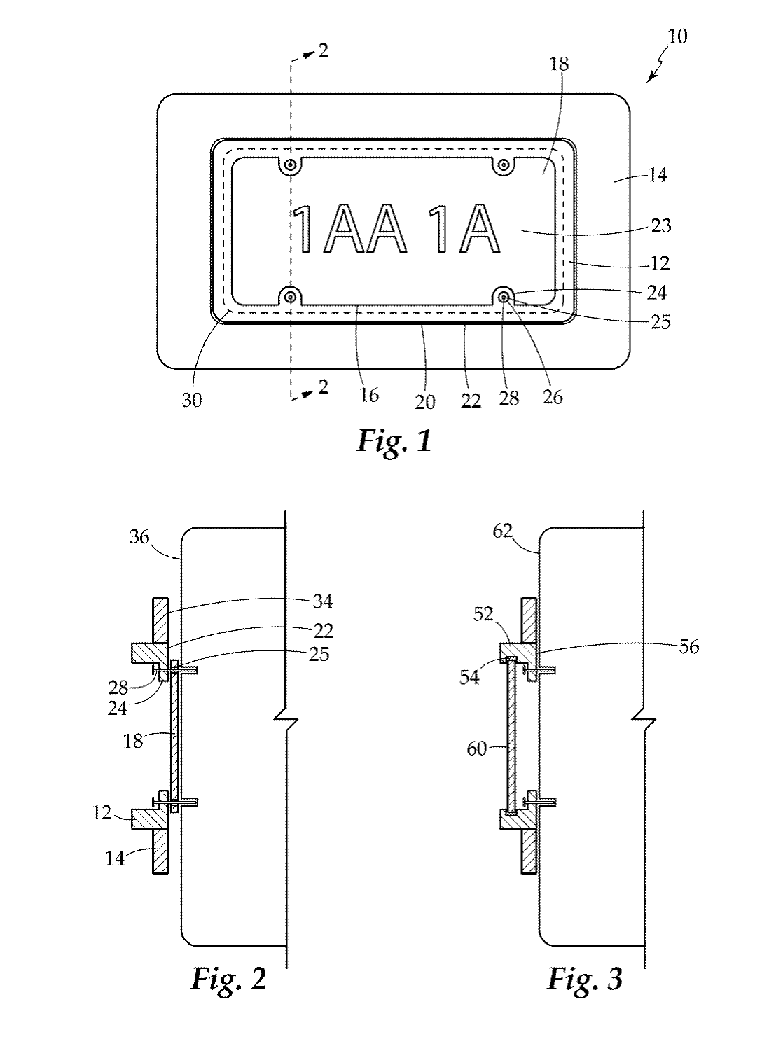

FIG. 1 illustrates the automobile protection device 10 of the present invention for use in preventing damage to a license plate and front and back fenders of an automobile. In its broadest context, the automobile protection device 10 has a first frame 12 surrounded by a second frame 14.

Standard license plates for automobiles have four holes which match the location of four holes on a typical front or back fender of an automobile. To secure a standard license plate to the fender of an automobile, an automobile owner aligns the holes of the license plate with the matching holes of the fender and uses screws to secure the license plate. The first frame 12 of the automobile protection device 10 utilizes these standard holes in the license plate and fender to couple the automobile protection device 10 and the license plate to the fender of an automobile. This provides protection and flexibility for use with all standard license plates and automobiles having such preexisting holes.

The first frame 12 of the automobile protection device 10 is substantially rectangular and is approximately seven inches (7″) in height, thirteen inches (13″) in width, and approximately one inch (1″) in thickness. The first frame has an inner edge 16 for bordering a license plate 18, an outer edge 20 which integrally couples with the second frame 14, and a back surface 22 (shown in FIG. 2). Preferably, the first frame 12 is made from rubber which absorbs impact and deflects damage to the license plate 18 and fender caused by debris, road obstacles, car washes and other minor collisions. In alternate embodiments, the first frame 12 is made from hard plastic. Other materials are contemplated which can protect the license plate 18 and fenders of an automobile from damage.

A plurality of tabs 24 extend from the inner edge 16 of the first frame 12. The tabs 24 are semicircular and have a circular hole 26. Preferably, four tabs 24 extend from the inner edge 16 of the first frame 12. The tabs 24 are positioned to align with the holes of a standard license plate 18 and the holes of the front fender 36 (shown in FIG. 2) of an automobile. Furthermore, the circular holes 26 are designed to accept screws 28 of the type commonly used with automobiles. This provides an easy to mount automobile protection device 10 as standard screws are used to secure the device 10 using already existing holes of the license plate 18 and front fender 36 of automobile.

The automobile protection device 10 is used for securing a license plate 18 to the front fender 36 of an automobile while protecting the license plate 18 and fender from damage. A license plate 18 for an automobile is typically approximately six inches (6″) in height and twelve inches (12″) in width and has four holes 25. The license plate 18 has corners 30 and a front face 23 which includes an identifying sequence for each automobile. When the circular holes 26 are aligned with the holes 25 of the license plate 18, the inner edge 16 of first frame 12 tightly borders the license plate 22 such that a one inch (1″) perimeter of the license plate 22 is covered by the first frame 12. This prevents the corners 30 of the license plate 18 from bending. Furthermore, the semicircular tabs 24 extending from the inner edge 16 of the first frame 12 allow the automobile protection device 10 to attach the license plate 18 to the fender 36 of an automobile without covering the front face 23 of the license plate 18.

The second frame 14 is substantially rectangular and is approximately nine inches (9″) in height, fifteen inches (15″) in width, and approximately one-half inch (½″) in thickness. The second frame 14 provides protection to the fender 36 of the automobile. The second frame 14 has an inside edge 30 which integrally couples to the outer edge 20 of the first frame 12 such that the second frame 14 surrounds the first frame 12. The inside edge 30 of the second frame 14 and the outer edge 20 of the first frame 12 are integrally coupled by a coupling means such as welding, soldering, or other similar means for coupling the first and second frames 12, 14. The second frame 14 has a back face 34 which aligns with the back surface 22 of the first frame 12. Therefore, when coupled together, the back surface 22 of the first frame 12 and the back face 34 of the second frame 14 are along a similar plane. The second frame 14 is preferably made of the same material as the first frame 12. Similar to the first frame 12, the automobile owner can selectively customize the second frame 14 according to preference in colors, logos, and slogans. It is contemplated that the first and second frames 12, 14 are customizable and interchangeable such that an automobile owner utilizes an online website to design an aesthetically pleasing device 10 according to their specific preferences.

FIG. 2 illustrates the automobile protection device 10 coupled to a front fender 36 of an automobile for protecting the license plate 18 and front fender 36. The automobile protection device 10 is described and illustrated in detail for the front fender 36 of automobile; however, the automobile protection device 10 is also suitable for the back fender of an automobile which mirrors the illustration of the front fender 36. The first frame 12 couples to the front fender 36 of automobile by aligning the circular holes 26 of the tabs 24 with the holes 25 of the license plate 18 and the front fender 36. Screws 28 secure the first frame 12 to the front fender 36. The back surface 22 of the first frame 12 rests against the license plate 18 when the automobile protection device 10 couples with the front fender 36 of the automobile.

When the device 10 couples to the front fender 36, the first frame 12 extends outward perpendicularly one-half inch (½″) from the second frame 14. This provides increased protection to the license plate 18 and acts as a first defense to prevent damage to the front fender 36. The first frame 12 deflects and absorbs impact from another automobile during a minor collision or parallel parking. The second frame 14 surrounds the first frame 12 and extends outward perpendicularly one-half inch (½″) from the front fender 36 acting as a second defense preventing damage to the front fender 36. Furthermore, during parallel parking automobiles are required to reverse into a parking spot. A front fender 36 with the device 10 coupled thereto is protected from scratches and dents caused by another car during parallel parking. If the parked car contains the device 10 on either bumper, the reversing automobile is prevented from contacting the front fender 36 regardless of the angle in which the reversing automobile collides with the first frame 12 of the parked car. In addition, if the parking car contains the device 10 similar protection is afforded. The first and second frames 12, 14 provide a wide surface of protection around the license plate 18 and a barrier to protect the front fender 36 of an automobile.

FIG. 3 illustrates a cross-sectional view of an alternate embodiment of the automobile protection device 50. The first frame 52 has a groove 54 extending therethrough. The groove 54 is substantially rectangular and extends upwardly from the inner edge 56 approximately one inch (1″) and is approximately one-eighth inch (⅛″) in thickness. The groove 54 is positionable approximately three-fourths inch (¾″) from the back surface 56 of the first frame 52. In this alternate embodiment, the license plate 60 slides into the first frame 52 along the groove 54. The first frame 52 couples to the front fender 62 of an automobile and the first frame 52 and second frame 64 protect the license plate 60 and front fender 62. This alternate embodiment, allows the automobile owner to easily change the license plate 60 without having to remove the automobile protection device 50 from the front fender 62 of the automobile. In this embodiment, it is contemplated that the device 40 is a standard feature on all automobiles, such that an owner simply slides the license plate 60 into position upon receiving the automobile and license plate 60.

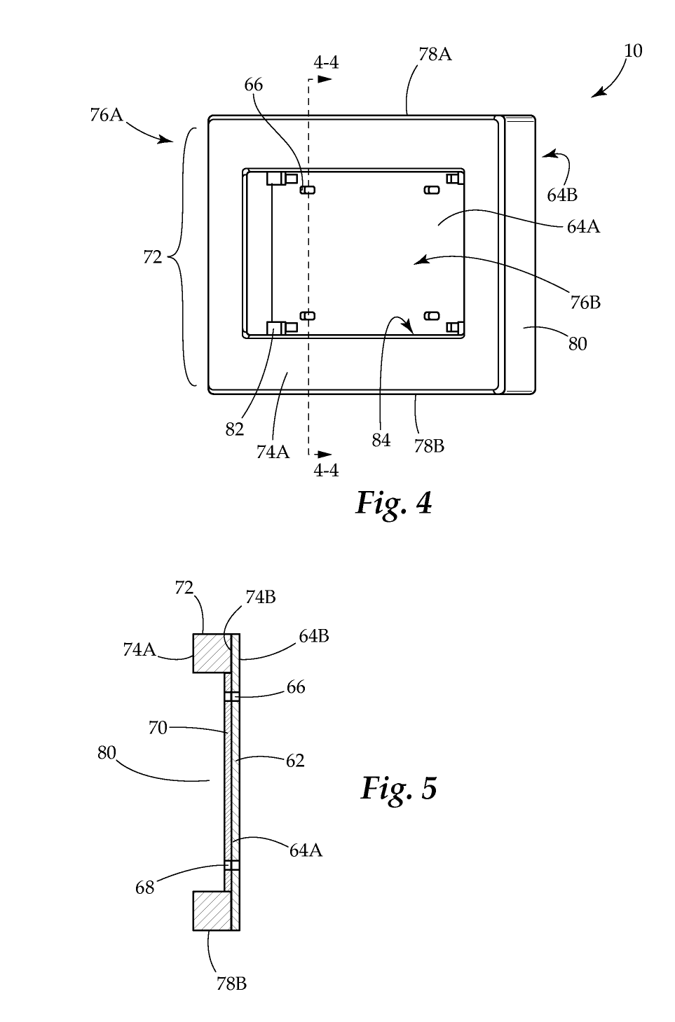

FIG. 4 illustrates a front-side perspective view of an alternate embodiment of the automobile protection device 10. In this embodiment, the automobile protection device 10 includes a first frame 62 having a front surface 64A and a back surface 64B and wherein the first frame 62 further includes a plurality of openings 66; each opening 66 is disposed to align with a corresponding hole 68 in a license plate 70, preferably to secure the device 10 and license plate 70 to an automobile (not shown). The first frame 62 is preferably surrounded by a second frame 72, wherein the second frame 72 includes a front side 74A and a back side 74B, such that the back side 74B of the second frame 72 is attached to the front surface 64A of the first frame 62. The second frame 72 further includes a pair of side portions 76A and 76B, and a top portion 78A and a bottom portion 78B. In one embodiment, the second frame 72 includes a recessed portion 80 to receive a license plate for securement to an automobile. Preferably, a plurality of tabs 82 is disposed along an interior edge 84 of the recessed portion 80 to provide another means to secure the license plate 70 in place.

FIG. 5 illustrates a cross-sectional view along line 4-4 of FIG. 4, wherein the second frame 72 surrounds the first frame 62 by the attachment of the back side 74B of the second frame 72 to the front surface 64A of the first frame 62.

Other embodiments are contemplated wherein the automobile protection device 10 of the present invention is suitable for automotive devices such as motorcycles, trucks, bicycles, boat trailers, and other similar automotive devices.

In conclusion, herein is presented an automobile protection device. The invention is illustrated by example in the drawing figures, and throughout the written description. It should be understood that numerous variations are possible, while adhering to the inventive concept. Such variations are contemplated as being a part of the present invention.

What is claimed is:

1. An automobile protection device comprising:
a first frame, wherein the first frame further comprises:
an inner edge;
an outer edge; and
a back surface;
a second frame, wherein the second frame is integrally coupled to the first frame by the outer edge of the first frame.

2. The automobile protection device of claim 1, further comprising:
a plurality of tabs extending upwardly from the inner edge of the first frame, wherein each tab further comprises a circular hole.

3. The automobile protection device of claim 2, wherein each hole located on each tab is disposed to align with a corresponding hole located on a license plate.

4. The automobile protection device of claim 3, wherein each hole located on each tab is disposed to accept a screw to secure the device and the license plate to an automobile.

5. The automobile protection device of claim 4, wherein the inner edge of the first frame borders the license plate upon being secured to an automobile.

6. The automobile protection device of claim 1, wherein the second frame further comprises:
an inside edge, wherein the inside edge integrally couples to the outer edge of the first frame, thereby causing the second frame to surround the first frame.

7. The automobile protection device of claim 6, wherein the inside edge of the second frame is integrally couple to the outer edge of the first frame by a coupling means selected from the group consisting of: welding, soldering and other similar means.

8. The automobile protection device of claim 6, wherein the second frame further comprises a back face aligned with the back surface of the first frame.

9. The automobile protection device of claim 8, wherein the alignment of the back face of the second frame to the back surface of the first frame is along a similar plane.

10. The automobile protection device of claim 6, wherein the first frame extends perpendicularly outwardly from the second frame upon being secured to an automobile.

11. The automobile protection device of claim 1, wherein the first frame further comprises a groove extending through the first frame and extending upwardly from the inner edge of the first frame.

12. The automobile protection device of claim 11, wherein the groove is disposed to receive a license plate for securement to an automobile.

13. An automobile protection device comprising:
a first frame, wherein the first frame further comprises:
a front surface;
a back surface; and
a plurality of openings located within the first frame
a second frame, wherein the second frame surrounds the first frame and further comprises:
a front side;
a back side;
a pair of side portions;
a top portion;
a bottom portion;
wherein the back side of the second frame is attached to the front surface of the first frame.

14. The automobile protection device of claim 13, wherein the second frame further includes a recessed portion to receive a license plate for securement to an automobile.

15. The automobile protection device of claim 13, wherein the second frame further includes a plurality of tabs extending upwardly from an interior portion of the second frame.

16. An automobile protection device comprising:
an inner frame comprising:
a facing surface; and
a backing surface comprising an attachment mechanism for attachment to an automobile and, an outer frame comprising:
a facing surface; and,
a backing surface;
wherein the backing surface of the outer frame is attached in outward juxtaposition to the facing surface of the first frame, and wherein the second frame comprises an inner area, bounded by four edges which create a void area disposed to retain a substantially rectangular member.

17. The automobile protection device of claim 16 wherein the second frame comprises a set of fastening devices to retain the substantially rectangular member.

18. The automobile protection device of claim 17 wherein the second frame comprises a set of fastening devices rigidly retain the substantially rectangular member.

19. The automobile protection device of claim 16 wherein the substantially rectangular member may be selected from the group consisting of a vehicle identification plate member, a vanity plate member and an automobile dealer plate member.
